(19) United States
(12) Patent Application Publication
(10) Pub. No.: US 2011/0248858 A1
(43) Pub. Date: Oct. 13, 2011

(54) Electrical Low Voltage Building Installation

(75) Inventors: Tamas Onodi, Thalwil (CH); Alexandre Ramirez, Saint-Louis Neuweg (FR)

(73) Assignee: Woertz AG, Muttenz (CH)

(21) Appl. No.: 13/082,696

(22) Filed: Apr. 8, 2011

(30) Foreign Application Priority Data
Apr. 11, 2010 (DE) 10 2010 014 548.3

(51) Int. Cl. G08B 21/00; H02H 3/08

(52) U.S. Cl. 340/635; 361/114

(57) ABSTRACT

An electrical low voltage building installation, wherein excess current protection devices are provided for conductor branch offs with cross-section reductions, wherein at least one distributor conductor is provided at which conductor branch offs for branch conductors with a reduced cross-section compared to the distributor conductor are arranged in the building in a distributed manner, wherein the associated excess current protection devices are arranged accordingly distributed at the conductor branch offs or subsequent to the conductor branch offs in the branch conductors, wherein the excess current protection devices that are arranged in a distributed manner are configured to be switched on again through remote control after triggering, and wherein the excess current protection devices do not require a remote control function for interrupting their respective conductor branch off or branch conductor, but perform the interrupting locally, this means upon their own determination of an excess current.

### FIELD OF THE INVENTION

The invention relates to an electrical low voltage building installation in which excess current safety devices are provided for conductor branch offs with reduced cross sections.

### BACKGROUND OF THE INVENTION

A typical configuration for a low voltage building installation is described e.g. in A. Hoesl and R. Ayz, “Die neuzeitliche and vorschriftsmaessige Elektroninstallation” Heidelberg, 12^{th} edition, 1996 on pages 56-59, 73-165. Accordingly initially one or plural main conductors follow after the transfer location of the electric utility company (so called house junction box) which carry electrical energy that has not been measured. The main conductors as a matter of principle are AC conductors and generally have conductor cross sections between 10 mm² and 120 mm² copper and are typically secured accordingly at the transfer location. In the main conductor or in the main conductors there are main conductor branch offs in the main conductor junction boxes (in buildings with plural metering devices), wherein the main conductor branch offs lead to the measuring devices e.g. electrical meters. After the electrical meter there is typically an AC conductor from the location of the meter to the so called power circuit distributor, wherein the AC conductor has to be configured with a conductor cross section of at least 10 mm² copper, and for installations in large buildings (high rises, commercial properties, etc.) often cross sections of at least 16 mm² copper are being used. In the power circuit distributor the conductor is divided into particular power circuits which lead to the consumers. The conductors of the particular power circuits typically have conductor cross sections of 1.5 mm² or 2.5 mm² copper. Due to the cross section reduction of 10/16 mm² copper to 1.5/2.5 mm² copper the particular circuits are secured against excess current through an excess current protection device (fuses or circuit breakers). Excess current protective devices are provided for each particular power circuit. The excess current protection devices associated with a particular current meter are typically combined in a control cabinet. Therein a distribution of the 10/16 mm² conductor into the particular power currents is provided through power rails with connection clamps placed there on.

FIG. 6 illustrates a prior art low voltage building installation in a schematic view. A conductor 3 with a large conductor cross section leads from an electrical meter 2 to a power circuit distributor 4 configured as a control cabinet 5. In the control cabinet 5 the conductor 3 is divided into a plurality of power circuits 6 which lead to the consumers 7. The conductors 8 of the particular power protection circuits 6 have smaller conductor cross sections. A respective excess current device configured as a safety circuit breaker 9 is arranged at the beginning of the circuit conductors 8 at the control cabinet 5.

### SUMMARY OF THE INVENTION

The invention on the other hand side provides an electric low voltage building installation wherein excess current protection devices are provided for conductor branch offs with cross-section reductions in which at least one distributor conductor is provided at which conductor branch offs to the branch conductors are provided, wherein the branch conductors have a reduced cross section compared to the distributor conductor and are arranged distributed over the building. Accordingly also the associated excess current protection devices are arranged in a distributed manner at the conductor branch offs or subsequent to the conductor branch offs in the branch conductors. The excess current protective devices which are arranged in a distributed manner are configured to be switched on again via remote control after triggering, this means interruption of the conductor branch off, wherein switching the excess current protection device back on means switching the interrupted conductor branch off or the branch conductor on again, thus making it conductive again. The excess current protection devices do not require any remote control function for interrupting their respective conductor branch off or branch conductor but perform the interruption locally, this means based on their own determination of an excess current.

Other features are inherent in the disclosed products and methods or will become apparent to those skilled in the art from the following detailed description of embodiments and its accompanying drawings.

### BRIEF DESCRIPTION OF THE DRAWINGS

Preferred embodiments are now described with reference to drawing figures,
wherein:

FIG. 1 illustrates a schematic circuit diagram of an embodiment of a low voltage building installation arranged according to the invention;

FIG. 2 illustrates a detailed circuit diagram of a detail of FIG. 2, namely a branch off with a branch off conductor, over current protection device with remote control and connected consumers;

FIG. 3 illustrates a perspective view of the installation elements for an embodiment of a building installation according to the circuit diagram of FIG. 2;

FIG. 4 illustrates a circuit diagram according to FIG. 2, however of an embodiment with wireless transmission of the remote control signals;

FIG. 5 illustrates a circuit diagram of an embodiment with a remote controlled excess current protection device which includes an error current protection device;

FIG. 6 illustrates a schematic circuit diagram of a prior art “centralized” low current building installation;

### DETAILED DESCRIPTION OF EMBODIMENTS

The inventors of the present invention have found that in the centralized arrangement of the branch offs and safety breakers 9 according to the prior art illustrated with reference to FIG. 6 the circuit conductors 8 in a control cabinet extend in parallel with one another to a considerable portion. They have found that this is not only relatively complex but makes planning and implementing a building installation and even more so the subsequent expansion even more difficult.

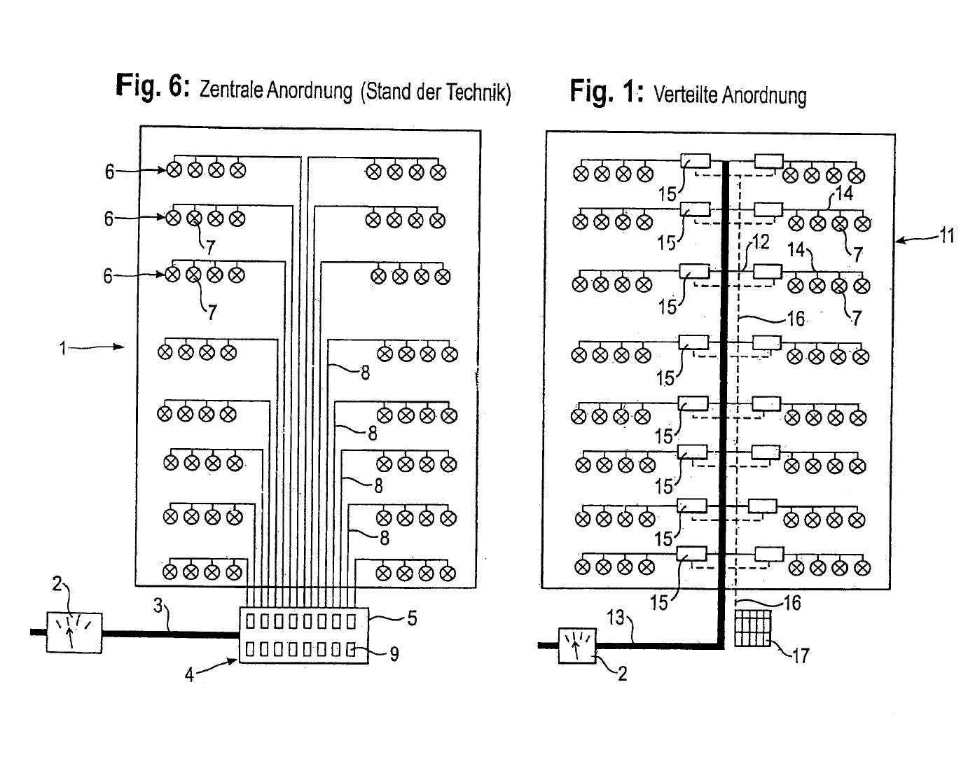

According to the embodiments of the invention this parallel arrangement can be avoided as illustrated in FIG. 1. The low voltage building installation 11 illustrated therein with a distributed arrangement of conductor branch offs 12 does not have any parallel arrangement of this type. A branch conductor 13 with larger cross section extends from the electric meter 2 proximal to the various consumers 7. The distributor conduit 13 with respect to its origin and conductor cross section thus corresponds to the conductor 3 which conventionally connects the control cabinet 4 with the electric meter 2. A control cabinet, however, is not provided and the distributor conduit 13, differently from the conventional conduit 3, extends far into the portion to be supplied with power. The conductor branch offs 12 are disposed proximal to the respective consumer 7 and are therefore arranged in a distributed manner along the distributor conduit 13. A respective branch conductor 14 with a reduced conductor cross section compared to the distribution conductor 13 branches off at a conductor branch off 12 from the distribution conductor 13. The branch conductors 14 with respect to their end points and their conductor cross sections correspond to the power circuit conductors 8 which conventionally originate in a control cabinet 4 from a distribution of the conductor 3. A control cabinet, however, is not provided and the branch conductors 14 respectively originate proximal to the supplied conductor 7. Thus, they do not extend parallel to one another and substantially only extend for a short distance from the passing distributor conductor 13 to the consumers 7 that are respectively being supplied.

Accordingly also the associated remote control protection devices 15 are arranged in a distributed manner according to the invention. In some embodiments they are arranged directly at the conductor branch offs 12. In other embodiments the excess current protection devices 15 are arranged on the other hand in the branch conductor after the conductor branch off 12. When the non secured portion of the branch conductor 14 is relatively short (e.g. not longer than e.g. 20-30 cm) the arrangement of the excess current protection device 15 is not acceptable directly at the conductor branch off 12, but is only acceptable in the branch conductor 14. Thus, the resistance of the non secured portion of the branch conductor 14 is small enough so that the breaker of the distributor conductor 13 that is installed up front in the non secured portion of the branch conductor 14 will turn off.

The excess current protection devices which are arranged in a distributed manner can be turned on again under remote control after triggering, this means interrupting the conductor branch offs 12 or the branch conductors 14, wherein the remote control signaling is illustrated in FIG. 1 through lines 16, wherein the signaling is performed between a switching center 17 and the particular distributed excess current protection devices 15.

The excess current protection devices 15 do not require any remote control function for interrupting their respective conductor branch offs 12 or branch conductors 14, but they perform the interrupting locally, this means based on their own determination of an excess current. Thus, even when the remote control fails or is limited with respect to its function, it is assured that e.g. for a short circuit in a branch conductor 14 the excess current protection device 15 associated with the branch conductor separates the branch conductors 14 from the distributor conductor 13, thus terminating the short circuit current flow. Only the repeat switch on would be affected by a failure of the remote control.

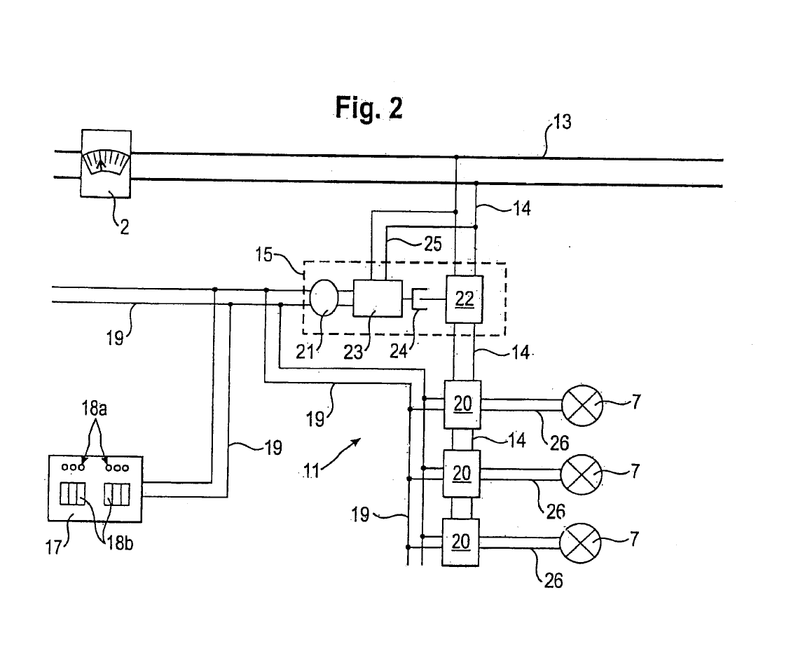

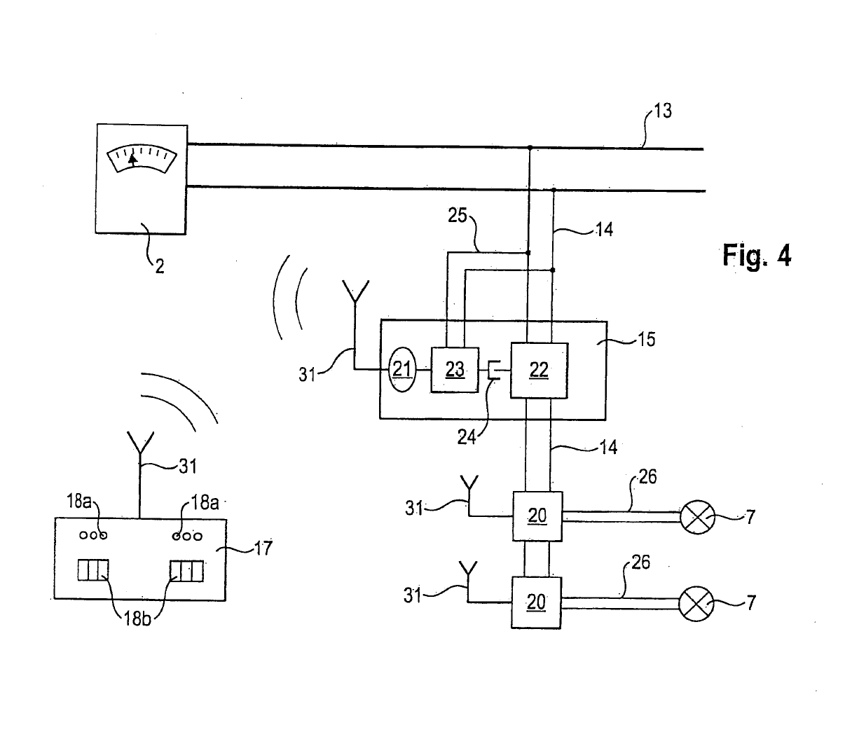

Thus, the electrical low voltage building installation as illustrated also in FIGS. 2 and 4 besides FIG. 1 also relates to the conductor installation at the electric meter 2. In the optional embodiment of a system with plural electric meters connected one after the other it relates to the conductor installation after the last current conductor in front of the consumers 7.

The excess current protection devices 15 that are arranged in a distributed manner are not arranged in a control cabinet 5, but are arranged distributed along the distributor conductor 13 which is run proximal to the consumers passing the excess current protection devices 15.

As illustrated in FIG. 1 the conductor branch offs 12 and the associated excess current protection devices 15 are distributed along the distributor conduit 13 so that a minimum total conductor length is generated for the distributor conduit 13 and the branch conductors 14.

Preferably the excess current protection devices 15 that are arranged in a distributed manner are arranged in hollow ceilings, hollow floors, hollow walls, cable channels and/or below stucco outlets.

Details of the remote control of the excess current protection devices 15 are now described with reference to FIGS. 2, 3 and 4.

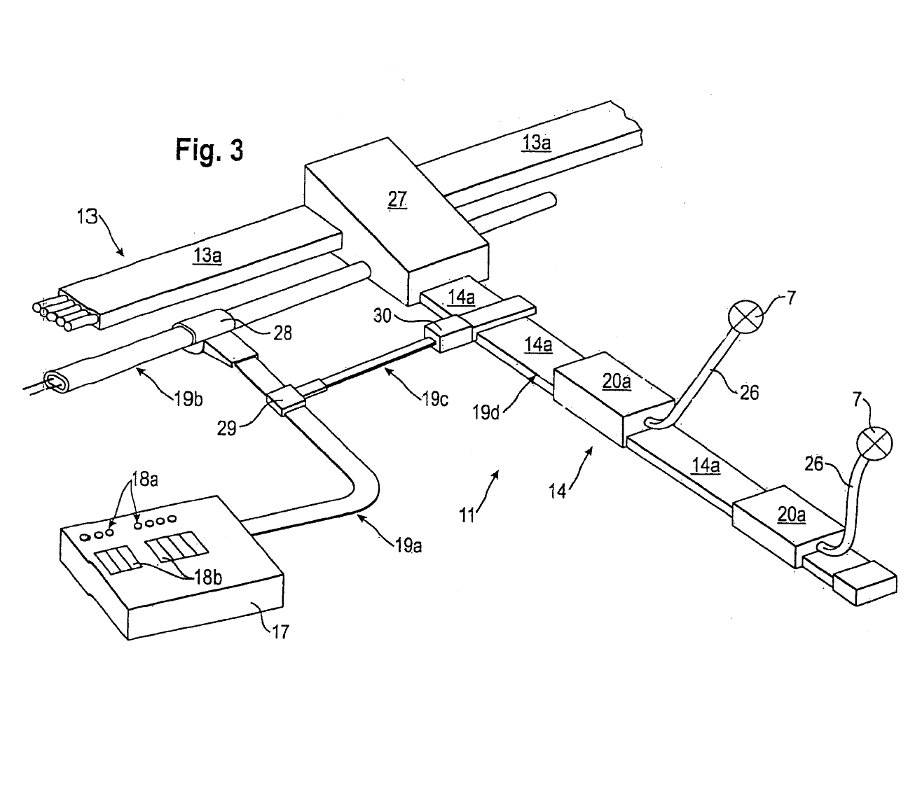

In order to centrally control, this means in particular turn the distributed excess current protection device 15 back on, the switching center 6 is used which is also designated as “control center” in FIGS. 2 and 3. Preferably the protection devices 15 that are arranged in a distributed manner are configured to transmit their present switching position to the switching center 6. For this purpose the switching center 17 includes a user interface for central command entry for the remote control for the distributed excess current protection devices 15, e.g. in the form of a key pad 18a with key sensors. Optionally it can also include a user interface for visualizing the condition of the distributed excess current protection devices 15, e.g. a display 18b configured as a screen or LED display.

The signals for the remote control for the excess current protection devices 15 and possibly for reporting its switching condition are transmitted in the embodiments of FIGS. 2 and 3 through a data cable to and from the excess current protection devices 15. Another embodiment with wireless signal transmission is illustrated infra with reference to FIG. 4.

As a matter of principle it would be possible to provide a data cable system in which each excess current protection device 15 to be controlled is connected with its own data conductor with the switching center 17 so that the addressing of the particular excess current protection devices 15 could be performed simply through the choice of the respective data conductor. In the embodiments illustrated in FIGS. 2 and 3, however, a data bus 19 is provided for these purposes through which the switching center 17 and the various excess current protection devices 15 are connected. In the embodiments of FIGS. 2 and 3 the data bus 19 is not only used for communication with the circuit breakers, but also for communications with actuators 20 for the consumers 7. The actuators 20 are e.g. remote controlled on/off switches, dimmers, climate controllers which can be used e.g. for load control, illumination control, solar protection control, air conditioning, emergency equipment control, etc. The consumer 7 is electrically connected with the branch conductor 14 e.g. through terminal conductors 26 and actuators 20. Data generated through sensors can also flow through the data bus 19 in the other direction. The data bus 19 is based e.g. on a data bus standard KNX, LON, CAN, etc. e.g. introduced in building installations. The excess current protection devices 15 are coupled through bus couplers 21 to the data bus 19. This applies accordingly for the switching center 17 and the actuators 20. The addressing of the particular bus elements, the switching center 17, the excess current protection devices 15 and actuators 20 is performed by providing the addresses of the bus elements in the data units put onto the bus which are often designated as “telegrams” in building installation bus systems. The signals for the remote control of the excess current protection devices 15 and optionally for reporting its switching condition are transmitted e.g. in the form of telegrams of this type through the data bus 19 to and from the excess power protection devices 15. The switching center 17 is thus coupled to the data bus 19 and communicates with the excess current protection devices 15 through the telegrams.

In the embodiments of FIGS. 2 and 3 the data bus 19 extends parallel to the distributor conductor 13 in order to couple with the excess current protection devices 15 which are arranged distributed along the distributor conductor 13. However, since the switching center 17 does not have to be located proximal to the distributor conductor 13, the data bus section leading towards the switching center 17 will typically not extend to the distributor conductor 13.

The excess current protection devices 15 respectively include a safety circuit breaker 22 and an electrical drive 23 for breaker for switching the excess current protection devices 15 back on via remote control in the embodiments of FIGS. 2-5. The safety circuit breakers 22 are configured to detect an excess current in their associated branch conductor 14 and to separate their associated branch conductor 14 under the load when an excess current is detected. Thus, they require no control signal from the data bus 19 or similar and also no external auxiliary energy; they rather have the energy that is necessary for separation stored themselves, e.g. in the form of elastic deformation energy in a spring that is loaded when the conductor is switched on for pass through, wherein the spring is unloaded for separating the conductor 14.

The electrical drive 23 is configured to bring its associated breaker from the triggered condition, in which the branch conductor 14 is separated, back into the switched on condition in which the branch conductor 14 is made conductive again and thus through remote control through the bus coupler 21 from the data bus 19. The mechanical drive 23 is thus connected with the safety circuit breaker 22 through a mechanical coupler 24. Besides the actual switch on movement the mechanical drive imparts the mechanical energy that needs to be stored in the safety circuit breaker through the mechanical coupler, so that the safety circuit breaker is configured and ready to break the connection e.g. in that it loads said spring again. For this purpose the safety breaker receives external energy. In the embodiments illustrated in FIGS. 2-4 the electrical drive 23 is connected with the distributor conductor 13 or the branch conductor 14 above the separation location of the safety circuit breaker 22 and thus receives it external energy from the high power grid. In other embodiments the power supply for the electric drive 23, however, is provided from the data bus 19; thus the connection device 25 can be omitted. The power supply from the data bus 19 can be provided through a low DC voltage e.g. 15 V which is applied to the data bus 19. An applied low DC voltage is also used as feed voltage for the bus electronics e.g. for the bus coupler 21 and is possibly also used for feeding sensors and actuators 20 and sensors coupled with the bus 19.

In some embodiments the safety circuit breaker 22 is a safety circuit breaker that is configured for manual, but not for remote controlled repeat switch on as it is typically used in power circuit distributors for conventional centralized building installations according to FIG. 6. The electrical drive 23 and the mechanical coupler 24 are separate modules and are configured and coupled to the safety circuit breaker 22 so that they perform a switch on movement at an actuator provided for manual switch on, wherein the actuation movement corresponds to a manual actuation movement. Furthermore, the excess current protection devices 15 also includes a reporting function. The current condition of the safety circuit breaker, thus whether it is triggered or switch on, is conducted through the bus conductor 21 and the data bus 19 as a telegram to the switching center 17 and illustrated therein possibly on the display 18b. For example, auxiliary contacts of the safety circuit breakers 22 are used as encoders for the present condition.

FIG. 3 illustrates an optional embodiment of the various conductors 13, 14 and 19 and installation elements for an embodiment of the building installation 11 according to the switching diagram of FIG. 2. Thus, the distributor conductor 13 is formed herein through a flat cable 13a with high power current strands extending in parallel in a plane. A flat cable of this type is described e.g. in DE-AS 2 206 187. The flat cable 13a typically has three phases and thus includes five or four strands, e.g. with a conductor cross-section of 10 mm² or 16 mm² the branch conductor 14 is formed by a hybrid flat cable 14a which includes high power current strands or data strands extending parallel in a plane. A hybrid flat cable of this type is described e.g. in EP 0 665 608 A2. The branch conductor 14 is e.g. a one-phase conductor. The hybrid flat cable 14a thus includes three (or two) high power current conductors e.g. with a conductor cross-section of 2.5 mm². Besides that the hybrid flat cable includes two data strands that are jointly shielded and run next to one another without being twisted, wherein the data strands form a symmetric data conductor and can be contacted similar to the high power currents strands of the flat cables 13a, 14a through tapping without stripping an insulation and without taking them apart at any longitudinal position of the flat cable 4. This data conductor forms the section 19d of the data bus 19 which extends parallel to the branch conductor 14. The other sections of the data bus are formed by separately extending data cables which are preferably also jointly shielded in order to facilitate tapping contacting and extend adjacent to one another in a plane without being twisted similar to the data conductor section 19d which forms a portion of the hybrid flat cable 14a. The other sections extend parallel to the flat cable 13a (section 19b). A distribution conductor flat cable 13a (section 19a) extends from the control center 17 and from section 19a to the branch conductor hybrid flat cable 14a (section 19c). The terminal conductors 26 are e.g. round cables or flat cables.

In the embodiment of FIG. 3 branch of junction boxes are provided for all cable and bus connections, wherein the branch off junction boxes are placed on one of the cables or buses and contact its continuous conductors without stripping insulation. A connection junction box 27 is applied to the distributor conductor flat cable 13a and the bus section 19b running parallel, wherein the connection junction box contacts one phase of the distributor conductor flat cable 13a and the data bus 19 and in which the access current safety device 15 possibly including the connection conductor 25 for supplying the electrical drive 23 is integrated. The branch conductor hybrid flat cable 14a is run out of the connection junction box 27. A bus conductor connection socket 28 is placed on the bus conductor section 19b contacting it and the bus conductor section 19a is run out of the bus conductor junction box to the switching center 17. Another bus conductor junction box 29 is applied to the bus conductor section 19a contacting the bus conductor section 19a. From the bus conductor junction box 29 a bus conductor section 19c is run out to the branch conductor hybrid flat cable 14a. A bus conductor junction box 30 is placed on the bus conductor section 19d integrated into the hybrid flat cable 14a contacting the Bus conductor section 19d. On the hybrid flat cable 14a there are one or plural activators 20a that are contacted without stripping insulation with the high power current conductors and the bus conductor section 19d, wherein terminal conductors 26 are run out of the activators 20a.

FIG. 4 illustrates an embodiment in which the control of the excess current protection device 15 is performed in a wireless manner, e.g. via radio or infrared through the switching center 6, the report from the switching center to the protection device 15 and possibly the control of the activators 20. For this purpose radio antennas 31 and suitable radio transmitters or receivers (or infrared transmitters and receivers) are provided at the excess current protection device 15, the switching center 6 and possibly the activators 20. Furthermore the statements made with respect to FIGS. 1 through 3 apply.

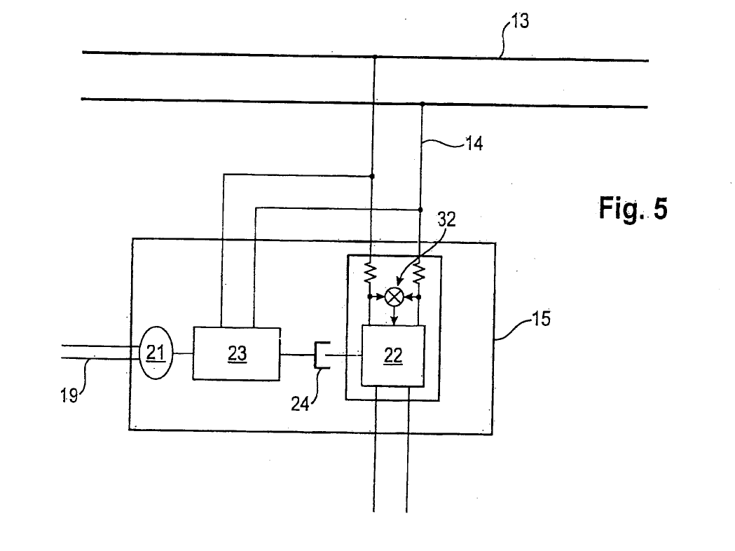

In some embodiments the excess current protection device 15 cannot only be triggered and turned on again through remote control, but can also be switched off through remote control by the switching center 17. This facilitates separating branch conductors 14 from the grid as required. This is illustrated in FIG. 5 in that a “command on-off” is entered for the bus entry into the excess current protection device 15.

FIG. 5 illustrates another embodiment in which the excess current protection device 15 also provides a conductor separation besides the excess current safety when an error current occurs in the branch conductor 14. An FI-switch 32 is used for this purpose which compares the current on the two current bearing conductors of the branch conductor 14 when the difference of the two currents exceeds a particular maximum value and triggers the safety circuit breaker 22. As described supra this is performed without external energy. The statements made supra in a context with FIGS. 1 through 5 apply to turning on the safety circuit breaker 22 again through the electrical drive 23 and the mechanical coupler 24, the power supply for the electrical drive 23 etc. Additionally the measured differential current can be reported back to the switching center continuously.

The invention relates to building automation with bus systems. Building automation with bus systems facilitates in principle wiring a building without a centrally arranged control cabinet. Large systems with distributed intelligence can be established and supplemented further any time. The simpler and more cost-effective wiring is a substantial advantage. The actuators are not placed in a center from where all consumers are being controlled with separate cable routing, but the actuators can be directly placed proximal to the consumers. All actuators and consumers can be connected to a cable loop. When this potential is used in an intelligent manner considerable savings can be implemented and are favorable solutions are also available for expanding the system. The basic concept of bus systems, however, is substantially upset by arranging prior art protective devices. Excess current and shorting are provided with a safety selectively where the conductor cross-section (the current load bearing capability) changes. The fuses or safety circuit breakers (excess current relay) according to the prior art have to be accessible for activation, thus they are in turn placed in a control cabinet from where the particular power circuits branch off. This necessity yields a central system again. The advantages of distributed intelligence can therefore be used with the prior art only for an unchanged cross-section and current bearing capability, thus with limitations.

Embodiments of the invention overcomes these disadvantages and implements the advantages of the completely distributed intelligence without impairing the original safety functions.

The idea is to put the excess current relays onto the cable, onto the nodes (branch off with changed cross-section) and to control the activation via remote control. This is performed as a telegram (command) through the data cable (bus). The particular protection devices, safety circuit breakers can be reached through the bus conductor under their own address. The configuration of the system includes e.g. the following elements:

Key sensor for command entry (switch on, switch off, testing)

Visualization of the condition of safety circuit breakers (LED or others)

Bus couplers depending on the bus system, e.g. KNX, LON, CAN . . .

Data cable

Unit side bus couplers

Mechanical activation (relay, stepper motor, . . . with mechanical coupling)

Safety circuit breaker (commercially available, any, with auxiliary contacts for condition detection)

Switching on and switching off is performed e.g. through the key sensor which is connected through bus couplers to the data cable and which transmits the switching commands as telegrams to the programmed address. The telegram triggers the movement in the mechanical activation unit for directly switching the safety circuit breaker. Switching on and switching off is thus performed by pressing a key. The current condition is in turn transmitted from the auxiliary contacts of the safety circuit breakers through the data cable as a telegram to the visualization.

When a short circuit or a non-permissible overload occurs in the protected power circuit the safety circuit breaker will immediately directly switch off the circuit and send the condition as a telegram to the visualization.

When switched on again, the command runs from the key sensor through couplers and data cables to the activation unit and the mechanics and initiates the attempt to turn it on again. In case the short circuit (overload) persists, the attempt remains unsuccessful, the safety relay triggers again irrespective of the activation mechanism. The condition indicator indicates “off” because it is controlled by the auxiliary contacts.

Only the key sensors with the visualization remain as a central unit, wherein the key sensors are connected with the data cable through a bus coupler. The unit only requires one data cable feed and no additional wiring. The energy distribution is completely disengaged from the control and monitoring unit. The wiring can be provided in a decentralized and very economical manner. Like the entire system, the unit can be expanded any time even without additional wiring complexity.

The safety circuit breaker can always be placed at the branch off. New branch offs can be provided any time.

The system with respective hardware and software adaptations can be used for all bus systems (KNX, LON, CAN, . . . ).

The system can be equipped with any commercially available safety circuit breaker and sensors and visualization (LEDs or screen). Possibly an adaptation between a mechanical activation unit and a safety circuit breaker is helpful. In this case tested and certified equipment can be selected for the safety relevant elements.

As a useful improvement the invention can be configured with safety circuit breakers with FI (error current protection) switches. In this case the branch off is not only switched off under overload, but also for an impermissible leakage current amount.

This embodiment can be visualized additionally (respective programming of additional LED). An additional sensor key can be used for a periodical checking of the FI switch.

For the safety of the personnel during maintenance and troubleshooting the center control unit can be configured with an additional key switch. By rotating and pulling the key out a repeat switch on through key pressure is blocked (software). The system cannot be turned on by accident.

In another embodiment the protective relay, the mechanical activation and the bus coupler are placed in the same housing. Thus, size can be significantly reduced.

It is another option to individually adjust the trigger current and the trigger times or delay times through the bus system through remote control.

Depending on the equipment type the parameterization of the safety circuit breakers can be performed through software.

A particular additional embodiment includes data transmission through infrared radiation without data cable connection. In this case, however, the transmitters and receivers are additional elements of the configuration and have to be placed accordingly (line of sight).

There is an option for data transmissions between the control unit and the safety circuit breakers via radio. The respective transmitters and receivers are already provided for the most bus systems. Depending on the configuration the range is up to 100 m and walls can even stand between the elements.

All publications and existing systems mentioned in this specification are herein incorporated by reference.

Although certain products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

### FIG. LEGEND

### FIG. 1—Distributed Arrangement (“Verteilte Anordnung”)

2 Electric Meter
13 Energy Supply
17 Controlling and Monitoring

### FIG. 2:

2 Electric Meter
7 Consumer
13 Distributor conductor e.g. 16 mm² (or 10 mm²)
14 Power Conductor (e.g. 25 mm²)
15 Excess Current Protection Device
17 Control Center
19 Data Cable
20 Actuators
21 Bus Coupler
22 Safety Circuit Breaker
23 Electric Drive
25 Electrical power supply for mechanical actuation

### FIG. 3:

7 Consumer
13a 5×16 mm² (or 3×16 mm²)
14a 3×2.5 mm²+Bus
17 Control center (Bus coupling, Key sensors, Visualization)
19b Bus conductor
20a Actuators contacted without stripping insulation
27 Excess Current Protection with additional Bus Control
28 Bus connection
29 Bus connection
30 Bus connection
   FIG. 4—Control via radio:
2 Electric meter
13 16 mm² (or 10 mm²) Power Conductor
Steuerung mit Funk—Control via radio
   FIG. 5—Excess current safety circuit breaker combined with error current breaker:
15 Excess current safety circuit breaker
19 Control on-off current differential testing
32 Error Current Breaker combination

### FIG. 6—Central Arrangement (Prior Art) (“Zentrale Anordnung (Stand der Technik)”)

2 Electric meter
3 Energy Supply
9 Safety Circuit Breakers

What is claimed is:

1. An electrical low voltage building installation,
wherein excess current protection devices are provided for conductor branch offs with cross-section reductions,
wherein at least one distributor conductor is provided at which conductor branch offs for branch conductors with a reduced cross-section compared to the distributor conductor are arranged in the building in a distributed manner,
wherein the associated excess current protection devices are arranged accordingly distributed at the conductor branch offs or subsequent to the conductor branch offs in the branch conductors,
wherein the excess current protection devices that are arranged in a distributed manner are configured to be switched on again through remote control after triggering, and
wherein the excess current protection devices do not require a remote control function for interrupting their respective conductor branch off or branch conductor, but perform the interrupting locally, this means upon their own determination of an excess current.

2. The electrical low voltage building installation according to claim 1, wherein the distributed arrangement of the conductor branch offs and the associated excess current protection devices relates to the conductor installation after an electrical meter, or for plural electrical meters connected in series, after the last electrical meter.

3. The electrical low voltage building installation according to claim 1, wherein the excess current protection devices arranged in a distributed manner are not arranged in a control cabinet, but along the at least one distributor conductor which is run proximal to consumers of the building installation.

4. The electrical low voltage building installation according to claim 3, wherein the branch off conductors with cross-section reduction and the associated excess current protection devices are arranged along the distributor conductor so that a minimum conductor length is achieved for the distributor conductor and the branch conductors.

5. The electrical low voltage building installation according to claim 1, wherein the excess current protection devices that are arranged in a distributed manner are arranged in hollow ceilings, hollow floors, hollow walls, cable channels and/or below stucco sockets.

6. The electrical low voltage building installation according to claim 1, wherein the excess current protection devices are controlled by a switching center.

7. The electrical low voltage building installation according to claim 1, wherein the excess current protection devices arranged in a distributed manner are configured to transmit their present switching conditions to a switching center.

8. The electrical low voltage building installation according to claim 1, wherein signals for remotely controlling the excess current protection devices and optionally for reporting their switching conditions are transmitted to and from the excess current protection devices wirelessly or through a data cable.

9. The electrical low voltage building installation according to claim 8,
wherein a data bus is provided for transmitting the signals wherein signals for remotely controlling the excess current protection devices and optionally for reporting their switching conditions,
wherein the excess current protection devices are coupled to the data bus with bus couplers, and
wherein the signals for remotely controlling the excess current protection devices and optionally for reporting their switching conditions are transmitted in the form of telegrams through the data bus to and from the excess current protection devices.

10. The electrical low voltage building installation according to claim 9, wherein the data bus runs parallel to the at least one distributor conduit.

11. The electrical low voltage building installation according to claim 1, wherein excess current protection devices are arranged directly at the branch offs from the distributor conduit.

12. The electrical low voltage building installation according to claim 11,
wherein the at least one distributor conduit is formed by a flat cable with strands that are run parallel in a plane,
wherein branch conductors are connected to the distributor conductor through branch off junction boxes applied to the flat cable which contact the distributor conductor without stripping an insulation, and
wherein the excess current protection devices are integrated into the branch off junction boxes applied to the flat cable.

13. The electrical low voltage building installation according to claim 1, wherein excess current protection devices are arranged in branch conductors.

14. The electrical low voltage building installation according to claim 13,
wherein the branch conductors are formed by flat cables with strands that are run parallel in a plane, and
wherein the excess current protection device are integrated into the branch off junction boxes applied to the flat cables.

15. The electrical low voltage building installation according to claim 1, wherein the excess current protection devices comprise an electrical drive for switching the excess current protection devices back on via remote control and the power supply for the drive is provided from the distributor conductor or possibly from the respective branch conductor in front of the separation location of the excess current protection devices.

16. The electrical low voltage building installation according to claim 9, wherein the excess current protection devices comprise an electrical drive for switching the excess current protection devices back on via remote control and the power supply for the drive is provided from the data bus.

17. The electrical low voltage building installation according to claim 1,
wherein the excess current protection devices comprise:
a safety circuit breaker that is configured for switching the excess current protection devices back on manually, but not via remote control, and
a separate remotely controllable electrical drive which is mechanically coupled with the manually actuatable safety circuit breaker and configured to switch the safety circuit breaker back on through an actuation movement according to a configured manual switch on movement.

18. The electrical low voltage building installation according to claim 1,
wherein the excess current protection devices are also configured as error current protection switches,
wherein also for the error current protection switching function for interrupting the respective conductor branch off or branch conductor no remote control function is required, but the interrupting is performed locally based on the error current, this means based on a proper determination of the error current through the respective error current protection switches.

19. The electrical low voltage building installation according to claim 1, wherein the excess current protection devices are not only configured to locally switch off the conductor branch off or the branch conductor when an excess current and possibly an error current occurs, but the excess current protection devices are also configured to switch off the conductor branch off or the branch conductor via remote control command.

20. The electrical low voltage building installation according to claim 9,
wherein the switching center is coupled to the data bus and communicates with the excess current protection devices through the telegrams, and
wherein the switching center can be arranged remote from the at least one distributor conductor.

21. The electrical low voltage building installation according to claim 6,
wherein the switching center comprises at least one of
a user interface for central command entry for the remote control of the distributed excess current protection devices, e.g. configured as a keypad,
and
a user interface for visualizing the condition of the distributed excess current switching devices, e.g. configured as a screen or as a LED display.
